(19) United States
(12) Patent Application Publication
(10) Pub. No.: US 2025/0257890 A1
(43) Pub. Date: Aug. 14, 2025

(54) MODULAR HEATING, VENTILATION AND AIR CONDITIONING MONITORING SYSTEM AND METHODS OF USE THEREFOR

(71) Applicant: ComfortAI LLC, Cupertino, CA (US)

(72) Inventors: Kyle LENEAU, Sunnyvale, CA (US); Patrick NELSEN, Minneapolis, MN (US); Albert Stephen CARR, III, Merritt Island, FL (US); Paul SAHOTA, Ontario (CA); Robert PARKER, Hillsborough, CA (US)

(21) Appl. No.: 19/049,726

(22) Filed: Feb. 10, 2025

Related U.S. Application Data
(60) Provisional application No. 63/551,914, filed on Feb. 9, 2024.

(51) Int. Cl. F24F 11/38; F24F 11/58; F24F 11/64; F24F 110/40; F24F 140/60

(52) U.S. Cl. CPC F24F 11/38; F24F 11/58; F24F 11/64; F24F 2110/40; F24F 2140/60

(57) ABSTRACT

A monitoring system having a plurality of sensors configured to collect sensor data associated with a heating, ventilation and air conditioning (HVAC) system, an edge processing unit proximate to the HVAC system and in communication with the plurality of sensors; wherein the plurality of sensors are configured to transmit the sensor data to the edge processing unit, and wherein the edge processing unit is configured to use trained artificial intelligence algorithms to predict the likelihood of failures of one or more components in the HVAC system based on the sensor data.

### RELATED APPLICATIONS

This application claims priority to U.S. Provisional Application No. 63/551,914 filed Feb. 9, 2024 and which is hereby incorporated by reference in its entirety.

### TECHNICAL FIELD

This disclosure is directed to a modular heating, ventilation and air conditioning (“HVAC”) monitoring system and methods of use therefor.

### BACKGROUND

Many residential and commercial HVAC systems rely on the subjective comfort of a user or a tenant as a means to monitor the health of the HVAC system. Conventional methods today require a human to notice a degradation in the system and alert an HVAC service provider. Often, the only tool at their disposal is the thermostat control.

Those residents and business owners with more affluent means may hire an HVAC technician to come to the residence to inspect the HVAC system annually and perform recommended preventative maintenance. Commercial HVAC systems may be monitored and maintained by building engineers and technicians who are trained to respond to detected problems and perform the recommended system maintenance. In each case, regardless of residential or commercial systems, HVAC operational monitoring and repairs is mostly reactionary. This leads to uneven maintenance demand cycles based on region, climate and availability. Even worse is that the conventional methods used today result in preventable or easily repairable anomalies that later become major and expensive repairs.

Understanding when an HVAC system begins operating out of its normal specifications before a failure is a difficult problem. Each HVAC system has its own components and configurations are unique to that system, made even more so by the operating environment in which they are installed. While some issues with an HVAC system manifest themselves immediately, many more will manifest over time. Even regular maintenance visits may not accurately diagnose this degradation.

Maintaining a residential or industrial HVAC system to prevent failures and ensure optimal overall system health is crucial. There is a need for an automated and continuous monitoring system that alerts an owner or building supervisor to problems and potential problems in a timely manner.

### SUMMARY

The present disclosure is directed to a monitoring system having a plurality of sensors configured to collect sensor data associated with a heating, ventilation and air conditioning (HVAC) system, an edge processing unit proximate to the HVAC system and in communication with the plurality of sensors, wherein the plurality of sensors are configured to transmit the sensor data to the edge processing unit, wherein the edge processing unit is configured to use trained artificial intelligence algorithms to predict the likelihood of failures of one or more components in the HVAC system based on the sensor data. The monitoring system may further include a network cloud infrastructure in communication with the edge processing unit, wherein the network cloud infrastructure provides the likelihood of failures of one or more components in the HVAC system to a web portal or an application running on a device. The edge processing unit may generate alerts based on the sensor data and wherein the alerts are based on a degradation of the HVAC system, wherein the degradation is based on a comparison of the sensor data to key performance indicators. The alerts may be posted to a web portal or an application running on a device.

In an aspect, the monitoring system may further include a thermostat mode recognizer configured to detect operating modes of the HVAC system based on sensor data having air pressure sensor data and current sensor data. The trained artificial intelligence algorithm may be trained using snapshots of sensor data points collected and labeled over a period of time and wherein the training is customized for a particular HVAC system.

In an aspect, the monitoring system may use an autoregressive integrated moving average statistical model to predict the likelihood of failures of components of the HVAC system.

The present disclosure is also directed to a monitoring system having a plurality of sensors configured to collect sensor data associated with a heating, ventilation and air conditioning (HVAC) system, an edge processing unit proximate to the HVAC system and in communication with the plurality of sensors, wherein the plurality of sensors are configured to transmit the sensor data to the edge processing unit, and wherein the edge processing unit is configured to use a trained artificial intelligence algorithm to ascertain a status of components of the HVAC system based on the sensor data. The status may have a health score of the HVAC system based on inputs to the artificial intelligence algorithm having long term sensor data associated with the HVAC system, maintenance logs, HVAC system metadata, and external factors. In an aspect, the status may include detection of an anomaly associated with a component the HVAC system. The artificial intelligence algorithm is one of a multi-scale convolutional recurrent encoder-decoder (MSCRED) model, local outlier factor (LOF), or model autophagy disorder (MAD) model. Inputs to the artificial intelligence algorithm may include a sequence of sensor data for a preceding time period and an output of the artificial intelligence algorithm may be a sequence of predicted data for a future time period. In an aspect, the monitoring system may have one or more sensors configured for monitoring voltage and current or refrigerant levels associated with the HVAC system.

The present disclosure is also directed to a method for evaluating status of a heating, ventilation and air conditioning (HVAC) system including collecting sensor data from a plurality of sensors, the sensor data relating to one or more components of the HVAC system, training an artificial intelligence algorithm based on the collected sensor data, developing one or more key performance indicators associated with the HVAC system, setting one or more thresholds associated with the key performance indicators, monitoring performance of the one or more components using one or more of the plurality of sensors, and comparing the performance of the one or more components to a corresponding one or more thresholds using the artificial intelligence algorithm, If the comparing step indicates that the performance of the one or more components does not meet the corresponding one or more thresholds, then the method may include generating an alert, wherein the alert includes a diagnostic assessment using the artificial intelligence algorithm. The artificial intelligence algorithm may be one of a multi-scale convolutional recurrent encoder-decoder (MSCRED) model, local outlier factor (LOF), or model autophagy disorder (MAD) model.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale, wherein like reference numerals refer to like elements.

FIG. 1 illustrates an exemplary operating environment for the present disclosure.

FIG. 2 illustrates an exemplary block diagram of an HVAC monitoring system in accordance with the present disclosure.

FIG. 3 is an exemplary flow diagram illustrating the training of an AI model in accordance with the present disclosure.

FIG. 4 is an exemplary flow diagram illustrating the generation and resolution of HVAC system alerts.

### DETAILED DESCRIPTION OF ILLUSTRATIVE EMBODIMENTS

System Overview. The present disclosure includes a modular HVAC monitoring system utilizing a combination of sensors strategically placed in and around the HVAC system, the use of edge and cloud computing power, and software employing AI algorithms. With respect to sensors, the HVAC monitoring system utilizes a combination of temperature sensors, air pressure sensors, current sensors, AC/DC voltage sensors, high pressure gas sensors and other sensors to continually monitor the operational characteristics of the HVAC system. For example, sensors may detect moisture or water damage from otherwise unmonitored condensation build up in the system and provide timely notifications to the user or service provider. The sensor data will be used to train artificial intelligence and/or machine learning algorithms (“AI”) as well as using heuristics and statistical data analysis to predict and alert a user or trained technician upon the occurrence of a failure or prediction of a failure. Sensor data will be tracked and analyzed in real time through edge and cloud computing processors, with certain time and latency critical processing pushed to the edge to reduce system analytics processing time. The cloud computing network maintains a comprehensive timeline which encompasses operational parameters, environmental measurements, identified issues and failures, operational characteristics, and other collected and analyzed data to enable a comprehensive lifetime view of the HVAC system. This will allow analysis and characterization of HVAC system performance across manufacturers' make, model and configuration in various regions and climates and based on time of day or other time periods.

Strategically placed sensors that measure temperature, pressure, voltage current, moisture and other conditions produce data that is continually ingested into the HVAC monitoring system to measure and determine actual operational temperatures, pressures, voltages, currents, moisture and other operating conditions. These measurements are then augmented through artificial intelligence, machine learning and statistical methods to create a comprehensive predictive model for the metrics of the operation of the HVAC unit. This allows for the prediction of failures and degradations of both the components of the HVAC system and the impact such failures and degradations may have on the entire HVAC system. The HVAC monitoring system also able to estimate energy usage, efficiency and operational failures of the system. Such estimates are useful in optimization of the operation of the HVAC system and to manage the energy use and lifetime of the HVAC system or its components. The present disclosure provides a practical application for customers, service providers, and manufacturers. For the customer and service providers, tracking and analysis of historical data may predict failures before they happen or, in the case when failures do occur, the present disclosure may reduce the amount of time required for diagnosis and correction. The HVAC monitoring system may educate customers on optimal use of energy systems and extend the lifetime of HVAC components. While customers may increase their piece of mind, service providers may remotely monitor their customers' HVAC systems and support their customers without a costly truck roll. Moreover, service providers may be able to optimize their labor pool and allocate their resources more cost effectively.

The present disclosure is much more than a system that simply performs the same functions as a technician, but rather is a practical application that advances the state of the art significantly. First, the HVAC monitoring system of the present disclosure provides continuous monitoring and real time analysis, twenty-four hours per day, seven days per week. Second, the diagnostic functionality is vastly improved over what a technician can provide. In an aspect, the HVAC monitoring system may diagnose problems in advance, before they happen or before they cause other problems, while technicians have to attempt to recreate how an HVAC system was put into a particular state. In an aspect, the HVAC monitoring system allows a retrospective analysis to better understand what was happening throughout the HVAC system before a fault or degradation happens which provides additional and better insight into the cause of the fault or degradation. Additionally, HVAC systems may suffer simultaneous failures or multiple serial failures that happen over a relatively short time period. The HVAC monitoring system of the present disclosure is not built on averages, but rather includes a personalization vector that analyzes the sensor data in a manner which enables for the compensation for regional weather, climate and other environmental conditions as well as being adaptable to various makes and models of HVAC system components.

Sensor data may be collected and used to train AI models. Maintenance schedules and problem resolutions may also be collected and used to train AI models. Fully trained AI models operating in a real time HVAC monitoring system may detect or anticipate maintenance issues or component failures and provide solutions.

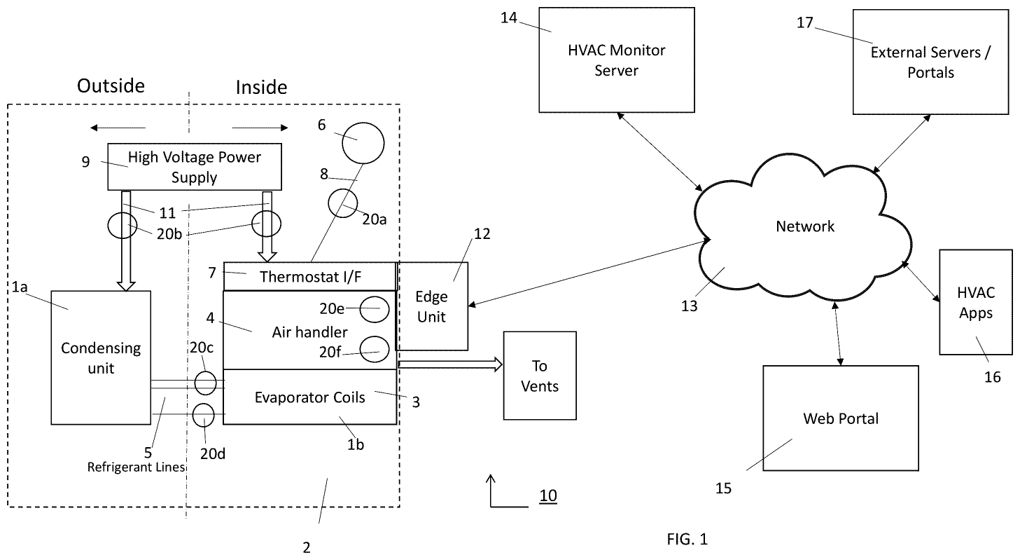

Operating Environment. FIG. 1 illustrates an exemplary embodiment of an HVAC monitoring system 10 constructed in accordance with the present disclosure. As an example, this operating environment shows the HVAC monitoring system 10 in a home environment 2 comprising an outside unit 1a and an inside unit 1b which illustrate some, but not all, of the elements comprising a heat pump system. Commonly each HVAC system operating environment 2 has airflow, temperature changes, power usage and control signals. It will be understood that while FIG. 1 shows an exemplary heat pump HVAC system, the HVAC monitoring system 10 as described in detail herein is modular and adaptable to any type of residential or commercial HVAC system. For example, FIG. 1 shows an air handler 4 which is often used in conjunction with a heat pump but does not show a furnace which may be part of a residential or commercial HVAC system in lieu of or in addition to an air handler 4. All such variations of HVAC systems are covered by the present disclosure and the appended claims.

As will be appreciated by those skilled in the art, the exemplary home environment 2 also includes a condensing unit as part of the outside unit 1a which is typically placed outside the home, connected to evaporator coils 3 which are typically found within inside unit 1b via refrigerant lines 5. There is a high voltage power supply 9 connected to the outside unit la and the inside unit 1b using high voltage power supply lines 11. There is also shown a thermostat 6 connected to a thermostat interface 7 of the inside unit 11 via thermostat connecting cable 8, which provides the thermostat control signal monitoring and power supply for the edge unit. Unless specifically described herein, the features and functionality of the components of the home environment 2 will be installed and operated in a typical fashion as understood by those skilled in the art. Likewise, in alternative home embodiments or any commercial embodiment, the components of such HVAC systems will also be installed and operated in a typical fashion as understood by those skilled in the art. Because of the applicability of the present disclosure to all types of HVAC systems, the home environment 2 will be described and referred to generically as HVAC system 2 throughout this disclosure.

Continuing with the description of FIG. 1, there is shown a series of sensors 20a, 20b, 20c, 20d, 20e, and 20f strategically placed throughout the HVAC system 2. There is also shown an edge device 12 that may, for example, be a computer configured to store computer instructions that are executed on an imbedded processor and collect and store sensor data. The edge device 12 may execute software applications and AI algortihms, including, for example, AI-based recognizers. Real time processing for HVAC system 2 alerts and sensor evaluation may occur in the edge device 12. The edge device 12 operates in closer in proximity to the HVAC system 2. Such proximity may enhance real-time processing and reduce latency and therefore provide more efficient analysis of the data generated by the HVAC sensors 20a-20f. This proximity enhances real-time processing and facilitates more immediate and efficient analysis of the data generated by the HVAC monitoring system 10. The edge device 12 may support a variety of communication protocols to allow for the integration with various IoT products in the home or business.

There is also shown a cloud computing network 13 which may, for example, be an AWS® cloud or a Microsoft® Azure® cloud, or any other commercial or private enterprise grade cloud computing network that can be adequately scaled. The cloud computing network 13 comprises a cloud infrastructure and including a variety of microservices, application programming interfaces (APIs), integrations, workflows and databases. The cloud computing network is where the relationship of HVAC systems is managed and stored. Web portals 16 and mobile applications 16 may interact with the cloud APIs to perform management tasks. Applications running on the edge device 12 also interact with the cloud computing network to report HVAC status and to upload sensor data.

The cloud computing network 13 may host the HVAC monitor server (shown separately as 14) which works in conjunction with the edge unit 12 for processing HVAC sensor data. It will be understood that in operation HVAC monitor server 14 may be integral with the cloud network 13. In an aspect, to enable secure and persistent connection between the edge device 12 and the cloud network 13, a secure VPN network may be deployed that allows the edge devices to be treated as an extension to the cloud network 13. Collectively, the edge unit and cloud computing network 13 and associated servers, portals, and applications will be referred to as the HVAC monitoring platform.

The HVAC monitoring system 10 may be used by multiple stakeholders, including manufacturers, building owners, residential customers, and HVAC service providers, utilities, and others. As such, the HVAC monitoring system 10 may include interfaces from the cloud computing network 13 to an HVAC application 16 running on a smartphone, tablet or personal computer and/or one or more web portal(s) 15, each configured to access and control the HVAC monitoring system 10.

In an aspect, the core administration of the HVAC monitoring system 10 may be performed through the web portal 15. The web portal may be controlled by a service provider, a building owner, technicians, administrators, or other stakeholders. This web portal 15 interacts with the application programming interfaces (“APIs”) to the cloud network 13. Exemplary features and functions of the web portal 15 may include, but are not limited to, the management of HVAC systems at customer locations, viewing and taking action on generated trouble tickets and/or alerts; monitor and diagnose service or maintenance issues on HVAC systems through various sensor views, and provide administrative and user access to the web portal 15.

In an aspect, there may be one or more mobile applications 16. For example, there may be an onboarding mobile application used by HVAC technicians to install and onboard the edge device 12 to the HVAC system 2. Such native onboarding mobile application facilitates the onboarding and collection of HVAC system 2 information. During installation and service visits the HVAC technician may use the onboarding mobile application to view sensor data, make adjustments to alert thresholds and resolve issues.

Another mobile application 16 may be a consumer mobile application. The HVAC monitoring system 10 may fully integrated with a consumer mobile application to allow the owner to view summary information relating to the status and operating condition of the HVAC system 2 and having a communication path to the consumer's HVAC service provider. In an aspect, self-help maintenance issues may also be highlighted to the consumer through the consumer mobile application, such as changing out of filters, restoring network connectivity, adding batteries to a thermostat, or other consumer serviceable features.

Because the mobile applications 16 may need to operate cellular and WiFi constrained environments, like the basement of a home where the HVAC system is located.

In an aspect, Bluetooth® Low Energy (“BLE”) may be used to connect mobile applications 16 to edge device 12 using an open an L2Cap socket. BLE allows a connection to the edge device 12 having a cloud connection requirement. Using such an open connection facilitates framing of standard HTTP messages to a software component running on the edge device 12 that unpacks the messages and forwards them to a standard HTTP proxy service that is locally hosted.

The mobile applications 16 may comprise one or more integrated components including a mobile SDK, a service running on the edge device 12 and a proxy on the edge device 12. Coordination between those components allows the mobile applications 16 to be developed similar to other standard mobile applications that communicate with REST services in the cloud. And allows flexibility to make changes and perform maintenance.

There may also be other external servers or portals. For example, external servers may supply a variety of data that may be used by the HVAC monitoring system 10, including climate data such as weather forecasts and weather history, power disruptions, emergency conditions, and other external data which may be useful to monitor the HVAC system 2 and predict events that may stress the HVAC system 2.

Also, there may be additional portals, which may, for example, allow manufacturers to monitor the performance of their HVAC components or systems, provide warranty services, and to supply spare parts. There may be a portal for utilities to monitor HVAC system usage and anticipate a surge in demand. It will be understood that these are exemplary only and the HVAC monitoring system 10 may include application programming interfaces (API's) or utilize HTTP protocols to provide access to the HVAC monitoring system 10.

Sensors. To enable the real time collection of HVAC system 2, multiple sensors 20a-20f are strategically placed throughout the HVAC system 2. The HVAC monitoring platform may have a modular configuration so as to be adaptable to various VAXC system configurations. The sensors 20a-20f create a multimodal sensing capability which, when coupled with AI/ML processing, enables the development of a comprehensive understanding of the HVAC system's 10 actual operations and performance.

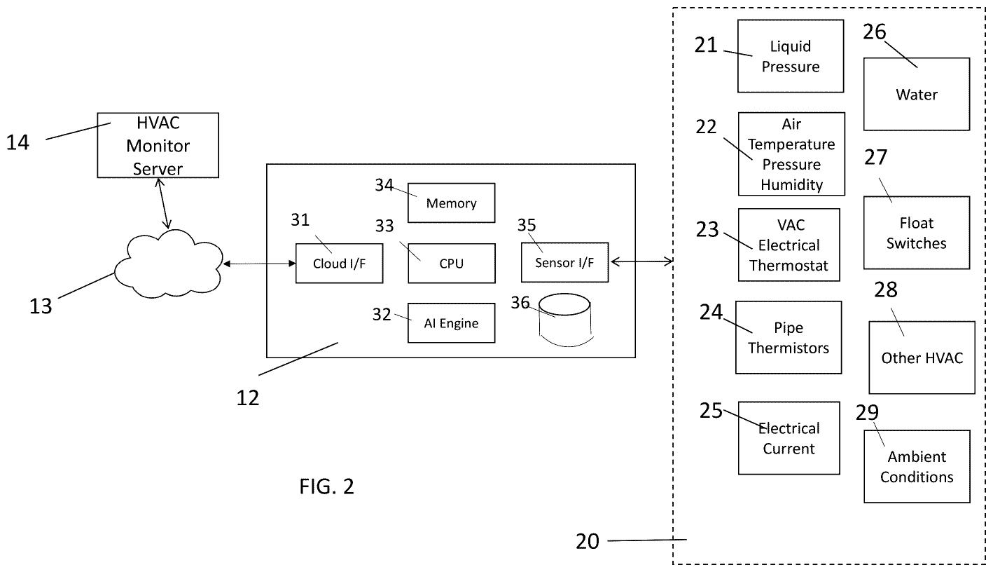

With reference to FIG. 2, there is shown the HVAC monitoring system 10 having an edge unit 12 and a set of sensors 20. The edge unit 12 may have a cloud interface 31. The present disclosure is applicable to any type of network 13, which may, for example, be an LTE or a 5G network. To communicate with the network 13 and or other IoT devices and systems, the edge unit 12 may have a direct or indirect communication interface for a wireless or wired communication system, which may, for example, be Wi-Fi, Bluetooth®, 3G, 46 LTE, and 5G, Wi-Fi, LAN, WiLan or any other wireless communication system. It will be understood by those skilled in the art that while the network 13 may comprise the afore-mentioned networks, a combination of one or more communication networks may be used.

In order to provide services to multiple edge units 12, resources within network 13 may be allocated to support such services. In an aspect, the network 13 will be a software defined network in which one or more VMs will be instantiated on hardware platforms within network 13. Such VMs may be allocated based on one or more criteria, including a geographic relationship with respect to edge unit 12, service level agreements, latency, priority, and any other criteria.

This edge device 12 allows running software at the edge of the HVAC monitoring system 10 and closest to the HVAC sensor data. This proximity to the sensor enhances real-time processing and facilitates more immediate and efficient analysis of the data generated by the HVAC system.

The allocation of processing between the edge unit 12 and the cloud computing network 13/HVAC monitor server 14 may be a design choice based on processing speed, latency, loading, and the like. The edge unit has a memory 34 for storing instructions to be executed by CPU 33. An AI engine 32 may be used for training and executing the AI/ML algorithms.

This edge device 12 has a sensor interface 35 to connect to the collection of sensors 20. A database 36 may be deployed on the edge unit 12 to capture sensor data in real time or to store historical sensor data.

The multi-mode sensors may include one or more of liquid pressure sensors 21, combination air temperature, pressure, and humidity sensors 22, 24-volt AC electrical thermostat sensors, pipe thermistor sensors 24, electrical current sensors 25, water sensors 26, float switches 27, other HVAC sensors 28, and ambient condition sensors 29, which may, for example, include ambient temperature, humidity, and barometric pressure in the vicinity of the HVAC system 2 and the areas served thereby. While the air temperature, pressure and humidity sensors 22 may be integrated, as a design choice, each may be an individual sensor or combined with another sensor function.

While the system is modular, in an aspect, the positioning of the sensors may include the following:

24-volt AC electrical thermostat sensor 24 (shown as 20a in FIG. 1) may be used to monitor thermostat connecting cable 8. This is the primary cable that is used for supplying power to the edge device 12 and for capturing the commands to the HVAC system 2. The 24-colt AC electrical thermostat sensor 24 captures the electrical signals to/from the HVAC system and the thermostat 7 and interprets those commands using a software algorithm.

Two of the combination air temperature, pressure and humidity sensors 22 (shown as 20e and 20f in FIG. 1 may monitor the air handler 4 or furnace (not shown) to measure static air pressure and Delta-T, the latter defined as the difference between return air temperature and supply air temperature which may, for example, be one measure of system efficiency and performance. A pair of combination air temperature, pressure, and humidity sensors 22 may be attached to the distal end of a support member to position the air temperature, pressure and humidity sensors 22 in the return air flow side and the supply air flow side. In an aspect, the support member may be deployed through a single ¼″ hole drilled in the HVAC venting with an adhesive mechanism to stick to the vent surface. This configuration provides a constant measure of static air pressure and allows the calculation of Delta-T.

Static air pressure and Delta-T are often key indicators and measurements that provide valuable insights into the operational behavior of the HVAC system 10. Combining a humidity sensor on the combination air temperature, pressure and humidity sensors 22 allows the computation in real-time the energy of dry and humid air. The difference in these energy computations is used as a measure of HVAC performance, energy use and efficiency.

Pipe thermistor sensors 24 (shown as 20c in FIG. 1) may monitor the temperature of the suction and liquid refrigerant lines 5 during system operation. Electrical current sensors 25 (shown as 20b in FIG. 1), or alternatively or additionally, voltage sensors, may monitor the current in amperage through the high voltage power supply lines 11. Liquid pressure sensors 21 (shown as 20d in FIG. 1) may monitor the pressure changes in the refrigerant lines 5 when the system is operating and/or idle. Ambient condition sensors 29, including air temperature sensors, may be installed at or near the HVAC system 2 or anywhere in the service area to monitor ambient air temperature. Additional sensors, including float switches 27 and water sensor 26 may monitor the HVAC system 2 to detect water accumulation. It will be understood that the configuration set forth above is exemplary only and in view of the modularity of the HVAC monitoring system 10, a plurality of sensor types may be deployed in any given HVAC system and some sensors may not be used in other HVAC systems. Additionally, in view of the modular nature of the HVAC monitoring system 10, other HVAC sensors may be developed, deployed, and the sensor data analyzed as part of the present disclosure.

### System Analytics

Automated AI Data Collection and Model Training. To assist in AI algorithm training and data analysis of a HVAC system 2, the HVAC monitoring system 10 will use its deployed sensors 20 to capture and store sensor data in snapshots. Snapshots in this case are defined as the collection of data points generated from the sensors and a period in time, either an instantaneous period or for a particular time range. The snapshots may thus include a time range of sensor data for a specific HVAC unit, system, location or some unique combination of all three. The HVAC monitoring system 10 may then label, organize and copy the relevant sensor data and store it for subsequent use by developers and data scientists to train AI models and to perform analysis of the HVAC systems.

The snapshots may be manually created by a developer or can be automatically created under control of the edge device 12. Moreover, as maintenance and repair issues are diagnosed and resolved, relevant sensor data may be collected before and after the issue is diagnosed and resolved, along with a resolution code, to further train and verify the AI models. Historical sensor data may be aggregated across HVAC systems to provide general analysis and may be segregated based on a particular HVAC system or components thereof.

Thermostat Mode Recognizer. Understanding the correct thermostat operating mode for an HVAC system is useful for other parts of the HVAC monitoring system 10. While many HVAC systems may gauge the mode of operation of the system based on the thermostat view of the system, namely by only monitoring the control lines from the thermostat. In an aspect, the HVAC system may enter a defrost cycle on its own to protect itself from damage and the thermostat would not necessarily know that information.

The present disclosure includes an AI thermostat mode recognizer which detects and captures operating modes from the HVAC system by utilizing air pressure sensors and current sensors and thereby derive an accurate operating mode for the HVAC system. This new thermostat mode is then fed back into the AI models for further training and analysis. In the example above wherein the HVAC system is in defrost mode, the sensor data collected during that time period will be tagged as being associated with defrost mode and as such, the HVAC system analysis will remain accurate.

### Edge-based HVAC Alerts

The present disclosure provides an alert system based on detection of the gradual degradation of an HVAC system. In an aspect, the alert function of HVAC monitoring system 10 defines a set of key performance indicators. The HVAC monitoring system 10 continuously evaluates sensor data in real time at the edge device 12 and compares the sensor data to a set of threshold values and determines whether the key performance indicators are being met. When one or more key performance indicators is out of specification, then the HVAC monitoring system 10 will records the occurrence of the event, determine whether the event is an issue and then passes the alert to the cloud network platform 13 which is then reported out to web portal 15 and mobile applications 16 for resolution by a customer service representative or trained technician.

The threshold values may be based on manufacturers specifications or derived and updated based on the AI models. Alternatively, the threshold values may be based on global defaults or updated manually.

Alerts may be generated for a variety of conditions. For example, an alert may be “Unit Failed to Start” and the associated sensor data may be analyzed by the AI model to diagnose the cause problem. The cause may be that the thermostat did not detect the proper mode or that there was a low voltage condition or some other fault with the system. The alert system may provide for either automatic remediation, which may, for example, include a “Restart” command, or generate a trouble report for resolution by a technician. Other alerts may be based on filters being clogged, low refrigerant levels or any other issue with the HVAC system and perhaps even a failed sensor.

### Multimodal System Health Scoring

Through the strategic analysis of sensor data gathered from continuous monitoring of the HVAC system, documentation of the HVAC system details recorded during installation, analysis of generated alerts, and examination of usage patterns, the AI models may calculate a streamlined HVAC system health score.

To calculate the HVAC system health score using AI models, input data may include long term sensor data collected from the HVAC system, maintenance and service history and repair logs, HVAC system meta data such as manufacturer, model, age and operating specifications, weather, HVAV usage logs and behaviors, customer feedback, and customer preferences. The AI model may utilize some or all of those factors, apply one or more sets of weights to the various factors, and predict the HVAC system health score based on analytics of other similar types of HVAC systems.

The HVAC system health score may be a key indicator and a summary report may be generated and ingested to provide feedback to the consumer and HVAC technician for informed decision making. The HVAC system health score may also provide advance notice of system failures or the need to replaces components.

Master Technician AI Labeling. When an alert is generated for an HVAC system, the HVAC monitoring system may provide the knowledge and tools to diagnose, adjust and resolve the issues associated with the alert. When resolving the issue, the technician may enter a code and comments relating to its resolution. This resolution code and commentary may form a rich category organized list of common and unique HVAC issues and preferred or recommended resolutions. Resolution of each issue may initiate creation and tagging of events for future analysis and AI model training which may enable the detection and/or prediction of issues earlier in the lifetime of an HVAC system.

The output of this process is an initial form of data labeling for AI and is focused around resolving issues with the operator in the web portal or the technician dispatched to the home.

Continuous Power Monitoring. In an aspect, the current sensors and voltage sensors may be combined and used to continuously monitor the power usage of the HVAC system 2. For example, high speed sampling of the current using current sensors may enable the HVAC monitoring system 10 to accurately determine the HVAC system 2 in start-up mode. Additionally, this sampling of the current may enable the HVAC monitoring system 10 to ascertain whether the igniters in a furnace have fired properly. The history of the high-speed samples may enable the HVAC monitoring system 10 to identify changes to the HVAC system 2 over time and the monitoring, recording and comparison of the current and voltage may become a leading indicator of predicting failures. For example, higher than expected values in current and voltage, and therefore power usage, may be an indication of low refrigerant levels which, over time, may lead to a fault or degradation of the HVAC system 2 or inefficient operation thereof.

By continuously monitoring voltage and current, valuable insight may be provided to a consumer or a service provider through the applications 16 or the web portal 15, respectively. Reports may be generated which provide for total energy used by cycle, day, month, year, season or more. This sensor data may be tracked in many forms and by computing kilowatt hours used by the system during a particular time period, the cost of operation may be determined and reported out through the applications 16 or web portal 15.

Continuous Refrigerant Monitoring. In an aspect, the HVAC monitoring system 12 may be used for maintenance and service predictions associated with the refrigerant levels as a means to maintain efficient operation of the HVAC system 2. Insufficient refrigerant levels may lead to an increase in energy consumption as well as diminishing the life span of the HVAC system. Additionally, the potential for leaks pose environmental hazards, emphasizing the importance of timely detection and repair. By leveraging the gas pressure sensors placed on the refrigerant lines of an HVAC system 2, the HVAC monitoring system is able to detect low refrigerant levels and potential leaks. By continuously monitoring these refrigerant lines, the sensor data may be used by the AI models to predict when refrigerant levels will reach a critical point that could disrupt the operation of the HVAC system and generate timely trouble tickets to prevent reaching that critical point.

Long-term Behavioral Recommendations. The HVAC monitoring system may use AI models and long-term usage data to provide recommendations to the user to affect longevity of the system, energy savings and routine maintenance.

HVAC Cycle Recognizer—The HVAC monitoring system may use AI models and long-term data to detect trends in cycles over time and predict optimal maintenance schedule or usage.

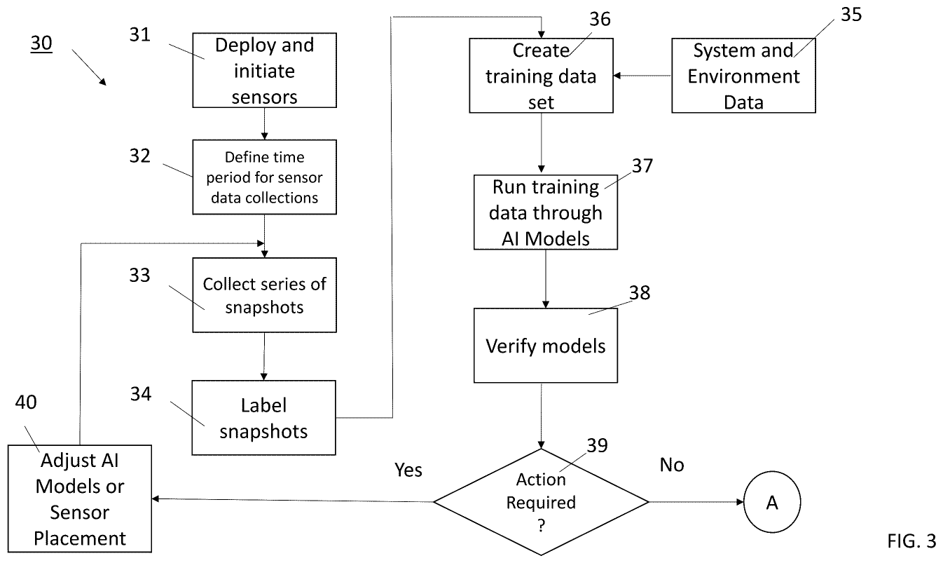

Methods of Use. With reference to FIG. 3, there is shown an exemplary flow diagram 30 which illustrates the training of the AI models which may be used in the HVAC monitoring system 10 of the present disclosure. At 31, the various sensors set forth above are strategically deployed in various positions in the HVAC system 2. At 32, a time period for collection of the sensor data is defined. The time period may include an instantaneous reading at a specific period of time and repeated in a defined time period. Alternatively, the time period may include a time range during which sensor data is collected continuously and the sensor data values averaged during that time period. At 33, a series of snapshots comprising the time-defined sensor data are collected and stored. At 34, the snapshots are labeled to identify features and functions associated with the sensor data.

Continuing at 35, HVAC system data, including manufacturer, model numbers, serial numbers, system configuration, location of the system within a building, and other system data are collected. Additionally, environmental data may also be collected. The environmental data may, for example, include ambient air temperature, pressure and humidity, geographical climate associated with location of the HVAC system, time of year, time of day, and other data that may be useful for the effective and accurate monitoring of the HVAC system.

At 36, a training data set is created based on the series of snapshots, system and environmental data. At 37, the training data is run through the AI model and the the training model goes through a verification step at 38 to determine if further training action is required at 39. If no further action is required, then the process continues at A which may, for example, be that the HVAC monitoring system is put into production use. If there is action required, the AI models may be adjusted at 40. Such adjustments may be to the inputs or the respective weighting of such inputs, the algorithms used, or the feedback of the outputs back into the AI model, or any other software adjustment that may be warranted or desired. Additionally, placement of the sensor hardware may be modified if it is determined that the sensor data collection is not optimal. After any suggested adjustments, the process may continue at 33 wherein a series of sensor data snapshots is performed.

It will be understood that while the flow diagram 30 shows the set up for one HVAC system, the process may be used across multiple HVAC systems and the sensor data snapshots and associated system and environmental data from the multiple HVAC systems may be used as a training data set for the AI models. The more data that is collected for AI training purposes, the more accurate the AI models will be.

While the example in FIG. 3 shows an exemplary method to train an AI model, the use of the AI model may include feedback loops wherein the outputs of AI models may be fed back into the AI model to further train and refine the model.

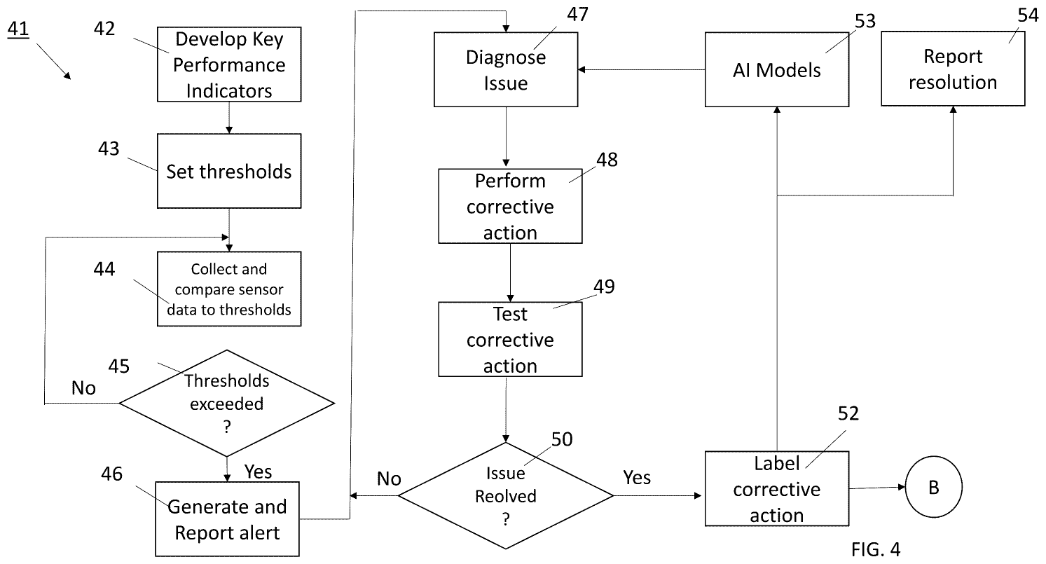

With respect to FIG. 4, there is shown an exemplary process flow 41 for HVAC system alerts generated by the edge device 12. At 42, key performance indicators for the HVAC system 2 are established. At 43, threshold values are set for one or more of the sensor data. At 44, sensor data is collected in real time and compared to the threshold values. At 45, the determination is made as to whether the threshold values are exceeded by the relevant sensor data. If not, the process continues at step 44 where the sensor data is continued to be collected in real time and compared to threshold values.

If one or more thresholds are exceeded, then an alert is generated and reported from the edge device 12 to the cloud platform 13 for viewing on a web portal 15 or mobile application 16. At 47, using AI models 53, the issue generating the alert is diagnosed and a trouble ticket prepared. At 48, correction action is performed, either automatically as determined by the AI models or manually by a service technician or system owner. At 49, the corrective action is tested to determine whether newly collected sensor data exceeds the thresholds. If it is determined that the issue has been resolved at 50, then the technician and/or the system will label the corrective action at 52 and the AI models will be updated at 53. The resolution will be reported from the edge device 12 to the cloud network 13 for access by the web portal 15 or mobile applications 16. The HVAC monitoring system 10 will continue normal operation at B.

If however, the system determines that the issue is not resolved at 50 because the thresholds for the key performance indicators have not been met, the system continues at 47 where the issue is once again diagnosed and the corrective action functions are repeated.

Artificial Intelligence Algorithms. The sensor data collected may be collected and analyzed in real time by the edge device. The collected sensor data may be received by the edge device 12 through sensor interface 35 and processed in real time by AI engine 32 and stored in database 36, or both. A variety of AI algorithms may be used for processing the sensor data. By way of example only, data from a single sensor, an autoregressive integrated moving average (“ARIMA”), a statistical analysis model that uses time series data to either better understand the data set or to predict future trends, may be used to analyze that sensor data. In another embodiment, long short-term memory (LSTM) network, a recurrent neural network (RNN) may be used to analyze single sensor or multiple sensor inputs. For mode detection, Gaussian Distribution models may be used.

For anomaly detection, AI algorithms may include Multi-Scale Convolutional Recurrent Encoder-Decoder (MSCRED), Local Outlier Factor (LOF), or Model Autophagy Disorder (MAD), each of which may be used to perform anomaly detection and diagnosis in multivariate time series data. In each case, after the AI models are trained, inputs to the AI algorithms may be a sequence of sensor data for the immediately preceding time period, which may, for example, be measured in seconds or minutes or longer, and the output of the AI algorithms may be a sequence of predicted data for a future time period.

### Information Technology, Hardware and Software

While examples of a HVAC monitoring system 12 have been described in connection with various computing devices/processors, the underlying concepts may be applied to any computing device, processor, or system capable of facilitating such a monitoring system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, Compact Disc-Read-Only Memory devices (CD-ROMs), Digital Versatile Discs, or, Digital Video Discs (DVDs), hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for an HVAC monitoring system. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a HVAC monitoring system as described herein also may be practiced via communications embodied in the form of program code that is transmitted over some transmission medium, such as over electrical wiring or cabling, through fiber optics, or via any other form of transmission, over the air (OTA), or firmware over the air (FOTA), wherein, when the program code is received and loaded into and executed by a machine, such as an Erasable Programmable Read-Only Memory (EPROM), a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

While the disclosure has been described in relation to a cloud-based network, it will be understood that the systems and methods disclosed herein may be deployed in both cellular networks and information technology infrastructure and support current and future use cases. Moreover, the architecture may also be used by carrier or third-party vendors to augment networks on the edge.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

In describing preferred methods, systems, or apparatuses of the subject matter of the present disclosure as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. In addition, the use of the word “or” is generally used inclusively unless otherwise provided herein.

This written description uses examples to enable any person skilled in the art to practice the claimed subject matter, including making and using any devices or systems and performing any incorporated methods. The patentable scope of the disclosed subject matter is defined by the claims and may include other examples that occur to those skilled in the art (e.g., skipping steps, combining steps, or adding steps between exemplary methods disclosed herein). Such other examples are intended to be within the scope of the claims if they have structural elements that do not differ from the literal language of the claims, or if they include equivalent structural elements with insubstantial differences from the literal languages of the claims.

What is claimed:

1. A monitoring system comprising:
a plurality of sensors configured to collect sensor data associated with a heating, ventilation and air conditioning (HVAC) system;
an edge processing unit proximate to the HVAC system and in communication with the plurality of sensors; wherein the plurality of sensors are configured to transmit the sensor data to the edge processing unit; and
wherein the edge processing unit is configured to use trained artificial intelligence algorithms to predict the likelihood of failures of one or more components in the HVAC system based on the sensor data.

2. The monitoring system of claim 1 further comprising a network cloud infrastructure in communication with the edge processing unit, wherein the network cloud infrastructure provides the likelihood of failures of one or more components in the HVAC system to a web portal or an application running on a device.

3. The monitoring system of claim 2 wherein the edge processing unit generates alerts based on the sensor data.

4. The monitoring system of claim 3 wherein the alerts are based on a degradation of the HVAC system, wherein the degradation is based on a comparison of the sensor data to key performance indicators.

5. The monitoring system of claim 4 further comprising a network cloud infrastructure in communication with the edge processing unit, wherein the network cloud infrastructure provides an output of the alert to a web portal or an application running on a device.

6. The monitoring system of claim 1 further comprising a thermostat mode recognizer configured to detect operating modes of the HVAC system based on sensor data comprising air pressure sensor data and current sensor data.

7. The monitoring system of claim 1 wherein the trained artificial intelligence algorithm is trained using snapshots of sensor data points collected and labeled over a period of time.

8. The monitoring system of claim 7 wherein the training is customized for a particular HVAC system.

9. The monitoring system of claim 1 wherein the artificial intelligence algorithm comprises an autoregressive integrated moving average statistical model to predict the likelihood of failures of components of the HVAC system.

10. A monitoring system comprising:
a plurality of sensors configured to collect sensor data associated with a heating, ventilation and air conditioning (HVAC) system;
an edge processing unit proximate to the HVAC system and in communication with the plurality of sensors; wherein the plurality of sensors is configured to transmit the sensor data to the edge processing unit; and
wherein the edge processing unit is configured to use a trained artificial intelligence algorithm to ascertain a status of components of the HVAC system based on the sensor data.

11. The monitoring system of claim 10 wherein the status comprises a health score of the HVAC system.

12. The monitoring system of claim 11 wherein the health score is based on inputs to the artificial intelligence algorithm comprising long term sensor data associated with the HVAC system, maintenance logs, HVAC system metadata, and external factors.

13. The monitoring system of claim 10 wherein the status comprises detection of an anomaly associated with a component the HVAC system.

14. The monitoring system of claim 13 wherein the artificial intelligence algorithm is one of a multi-scale convolutional recurrent encoder-decoder (MSCRED) model, local outlier factor (LOF), or model autophagy disorder (MAD) model.

15. The monitoring system of claim 14 wherein an input to the artificial intelligence algorithm comprises a sequence of sensor data for a preceding time period and an output of the artificial intelligence algorithm is a sequence of predicted data for a future time period.

16. The monitoring system of claim 10 further comprising one or more sensors configured for monitoring voltage and current associated with the HVAC system.

17. The monitoring system of claim 10 further comprising one or more sensors configured for monitoring refrigerant levels associated with the HVAC system.

18. A method for evaluating status of a heating, ventilation and air conditioning (HVAC) system comprising:
collecting sensor data from a plurality of sensors, the sensor data relating to one or more components of the HVAC system;
training an artificial intelligence algorithm based on the collected sensor data;
developing one or more key performance indicators associated with the HVAC system;
setting one or more thresholds associated with the key performance indicators;
monitoring performance of the one or more components using one or more of the plurality of sensors; and
comparing the performance of the one or more components to a corresponding one or more thresholds using the artificial intelligence algorithm.

19. The method of claim 18 wherein if the comparing step indicates that the performance of the one or more components does not meet the corresponding one or more thresholds, then generating an alert.

20. The method of claim 19 wherein the alert includes a diagnostic assessment using the artificial intelligence algorithm.

21. The method of claim 20 wherein the artificial intelligence algorithm is one of a multi-scale convolutional recurrent encoder-decoder (MSCRED) model, local outlier factor (LOF), or model autophagy disorder (MAD) model.
